(19) United States
(12) Patent Application Publication
(10) Pub. No.: US 2009/0089679 A1
(43) Pub. Date: Apr. 2, 2009

(54) INFORMATION PROCESSING DEVICE, INFORMATION PROCESSING METHOD, AND STORAGE MEDIUM STORING INFORMATION PROCESSING PROGRAM

(76) Inventor: Takashi MIYAMOTO, Saitama-ken (JP)

Correspondence Address: BIRCH STEWART KOLASCH & BIRCH, PO BOX 747, FALLS CHURCH, VA, 22040-0747, US

(21) Appl. No.: 12/204,595

(22) Filed: Sep. 4, 2008

(30) Foreign Application Priority Data
Sep. 28, 2007 (JP) 2007-256350

(51) Int. Cl. G06F 3/048

(52) U.S. Cl. 715/733

(57) ABSTRACT

An information processing device includes a storage component that stores browsing screen data that is provided at an external device and create a browsing screen that is displayed on a display of the external device as a result of the external device interpreting and executing the browsing screen data; an acquisition component that acquires content update data for updating the browsing screen data; and an update component that updates the browsing screen data based on the content update data.

### CROSS-REFERENCE TO RELATED APPLICATION

This application claims priority under 35 USC 119 from Japanese Patent Application No. 2007-256350, the disclosure of which is incorporated by reference herein.

### BACKGROUND OF THE INVENTION

1. Field of the Invention

The present invention relates to an information processing device, an information processing method and a storage medium storing an information processing program, and in particular to an information processing device, an information processing method and a storage medium storing an information processing program storage medium that update rich contents information in a web system or a website on a network.

2. Description of the Related Art

Conventionally, in the field of web technology, there is a technology for handling rich contents including contents such as video and audio that are displayed by a display component (display or browser) of a client as a result of a client device (terminal) interpreting and executing the contents. This rich contents technology controls audio and video by a script program, for example. It is common for rich contents information (data) including characters, audio and video for realizing (creating) the rich contents to be created by a designer using a dedicated application on a personal computer, for example, and to be stored in a server as static data.

In relation to this technology, in Japanese Patent Application Publication (JP-A) No. 2003-196093, there is disclosed a technology relating to a mechanism that absorbs differences in interfaces per service and ways of usage when a user selects, combines and uses services that are dispersed and numerously present on a network (e.g., the Internet). In the aforementioned document, this mechanism is called a “scenario”, and this scenario is described by a script program. Additionally, this script is executed on a server system rather than on a client terminal. This implementation is a typical example of a method for using a script in a web system.

Further, in JP-A No. 7-160617, there is disclosed a technology that integrates services that are dispersed and numerously present on a network with a center server to provide a unified interface with respect to a user. In this technology, a client terminal and the center server communicate by a specifically developed script language, and the center server translates this script into individually different interfaces of servers that provide the respective service (functions).

In such technology, when the content of rich contents information are to be dynamically changed per user, it becomes necessary to dynamically create rich contents information that is not static data at a server end.

When rich contents information is created by a server, a typical example is as follows. First, input data such as shown in FIG. 8A is prepared. The input data may be created by a markup language or a structured language such as XML format, for example. In the case of the input data of FIG. 8A, data is dynamically set by the server in portions enclosed by “<%” and “%>”, whereby the data become the data shown in FIG. 8B. The data shown in FIG. 8B is interpreted and converted to rich content information, and a browsing screen such as shown in FIG. 8C is displayed in a web browser.

However, when such a configuration is employed, separation of the areas of responsibility of a designer who designs the outer appearance and layout of the screen shown in FIG. 8C and a system developer who designs the behavior and operation of the screen (system) becomes incomplete, and problems may occur in terms of the operation of the system.

Stated in terms of the above example, the designer ordinarily designs rich contents information using client software for a screen design that operates on a personal computer and is friendly for the designer. For that reason, when data of a unique format such as shown in FIG. 8A and FIG. 8B are employed, ordinary client software for screen design that the designer uses can no longer be used, and working efficiency ends up dropping.

For that reason, an example exists where this problem is avoided to a certain extent by providing a converter that converts data that have been created by the client software that the designer uses into data of a format such as shown in FIG. 8A. However, in that case, it takes effort to specify the places (portions enclosed by “<%” and “%>” in FIG. 8A) where the data are dynamically set.

On the other hand, there are many cases where the system developer is familiar with data in XML format or the like such as shown in FIG. 8A and FIG. 8B but is not familiar with the design of rich contents information (screens). For that reason, it takes time to understand the content when data in XML format, in which information relating to the design is also included, is delivered, and the work of embedding “<%” and “%>” ends up taking time.

Moreover, even after work has been completed, it is necessary for both the designer and the system developer to collaborate and perform alterations each time there is a slight design change, which becomes a factor in pushing up operational costs.

In this manner, in the conventional art, a lot of effort and expense has been necessary to change and update rich contents information.

### SUMMARY OF THE INVENTION

In view of the above circumstances, the present invention provides an information processing device, an information processing method and a storage medium storing an information processing program that enables rich contents to be updated easily.

A first aspect of the present invention is an information processing device including: a storage component that stores browsing screen data that is provided to an external device and creates a browsing screen that is displayed at a display of the external device as a result of the external device interpreting and executing the browsing screen data; an acquisition component that acquires content update data for updating the browsing screen data; and an update component that updates the browsing screen data based on the content update data.

In the above-described aspect, the information processing device may be configured such that the browsing screen includes at least one content segment, the content update data includes an identifier that identifies the content segment included in the browsing screen, and the update component updates the browsing screen data by breaking down the browsing screen data into a set of data representing the content segment included in the browsing screen, and replacing the content segment data identified by the identifier included in the content update data with the content update data.

In the above-described aspect, the information processing device may be configured such that the browsing screen data includes character string data that represents a character string included in the browsing screen, image data that represents an image included in the browsing screen, and image identification data that identifies the image included in the browsing screen.

In the above-described aspect, the information processing device may be configured such that the browsing screen data is XML format data.

A second aspect of the present invention is an information processing method including: storing browsing screen data that is provided to an external device and creates a browsing screen that is displayed on a display of the external device as a result of the external device interpreting and executing the browsing screen data; acquiring content update data for updating the browsing screen data; and updating the browsing screen data based on the content update data.

The second aspect acts in the same manner as the first aspect, so effects that are the same as those of the first aspect can be obtained.

A third aspect of the present invention is a storage medium storing a program that causes a computer to execute information processing, the computer storing browsing screen data that is provided to an external device and creates a browsing screen that is displayed on a display of the external device as a result of the external device interpreting and executing the browsing screen data, the information processing including: acquiring content update data for updating the browsing screen data; and updating the browsing screen data based on the content update data.

According to the third aspect, a computer functions in the same manner as the information processing device of the first aspect, so effects that are the same as those of the first aspect can be obtained.

### BRIEF DESCRIPTION OF THE DRAWINGS

An exemplary embodiment of the present invention will be described in detail based on the following figures, wherein:

FIG. 1 is a diagram showing an information processing device pertaining to the exemplary embodiment, a portable terminal that is an exemplary external device, and a network and a base station that interconnect these;

FIG. 2 is a diagram showing the configuration of a server;

FIG. 3 is a diagram showing template data;

FIG. 4A and FIG. 4B are diagrams showing content update data and script data;

FIG. 5 is a flowchart showing update processing;

FIG. 6 is a schematic diagram showing the update processing;

FIG. 7 is a diagram showing a configuration that includes a file server; and

FIG. 8A to FIG. 8C are diagrams showing conventional art.

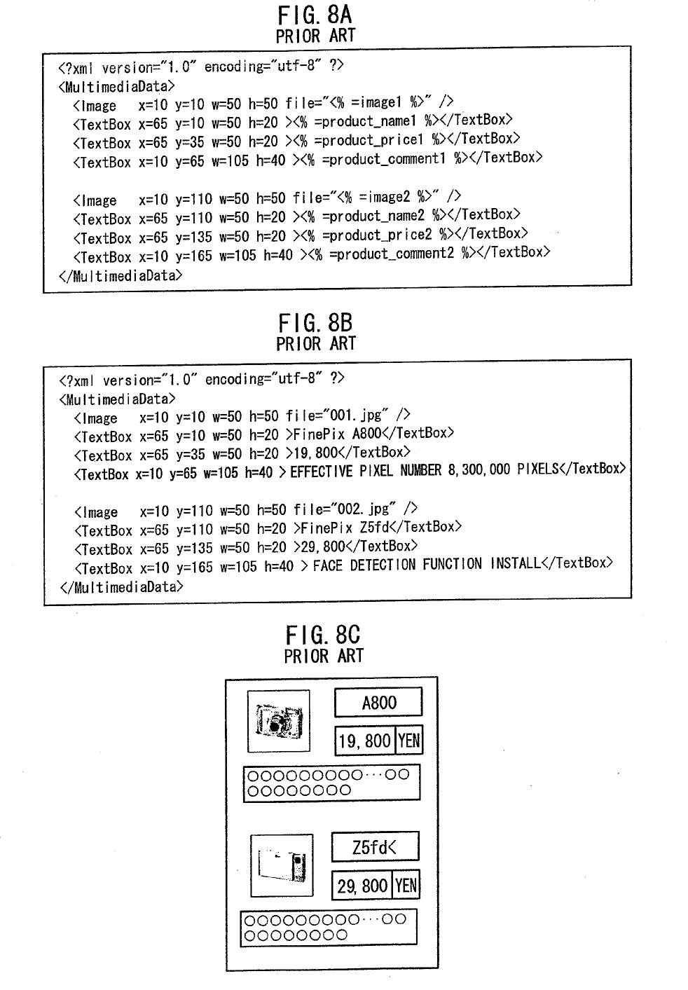

### DETAILED DESCRIPTION OF THE INVENTION

Below, an exemplary embodiment of the present invention will be described in detail with reference to the drawings.

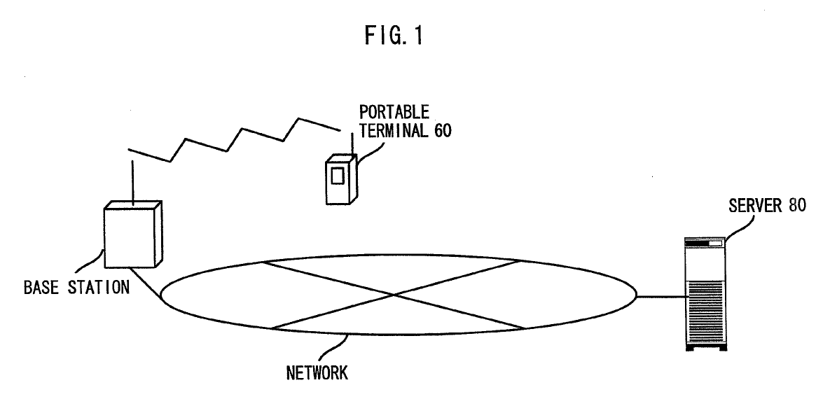

In FIG. 1, there are shown an information processing device (below, called a “server 80”) pertaining to the present exemplary embodiment, a portable terminal 60 that is an exemplary external device, and a network and a base station that interconnect these. The server 80 shown in FIG. 1 provides, via the network, browsing screen data in which is included content (screen) information that is displayed by a display (browser) of the portable terminal 60 as a result of the portable terminal 60 interpreting and executing the browsing screen data. In FIG. 1, the external device is the portable terminal 60, but this is only one example; the external device is not limited to a portable terminal and may also be a personal computer or the like.

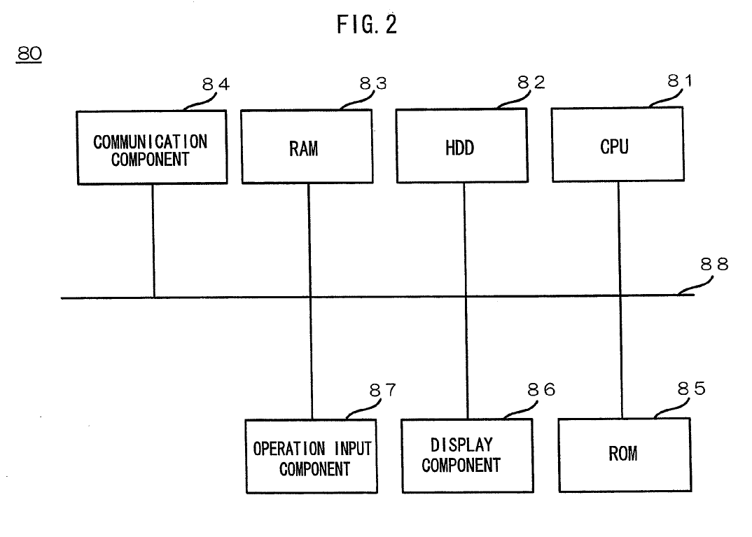

Next, the configuration of the server 80 will be described using FIG. 2. The server 80 includes a CPU 81, an HDD 82, a RAM 83, a communication component 84, a ROM 85, a display component 86, an operation input component 87 and a bus 88.

The CPU 81 controls operation of the entire server 80, and processing by the server 80 that is shown in a later-described flowchart is executed by the CPU 81. The HDD 82 is a non-volatile storage device in which an OS and programs are stored. Moreover, the HDD 82 stores browsing screen data (below, called “template data”) serving as rich content information that includes characters, audio and video for realizing rich content, content update data, and script data that update the template data on the basis of the content update data.

The RAM 83 is a volatile storage device in which the OS, the programs and the data are deployed (temporarily stored). The communication component 84 is for connecting to the network and is configured by an NIC and an NIC driver. The ROM 85 is a non-volatile storage device in which are stored a boot program and the like that are activated when the server 80 starts up. The display component 86 displays information relating to the server 80 for a user. The operation input component 87 is used when a user inputs operations and information of the server 80. The bus 88 is used when exchange of information or data is performed between the aforementioned functional components.

Next, the template data, the content update data and the script data that are stored in the HDD 82 will be described.

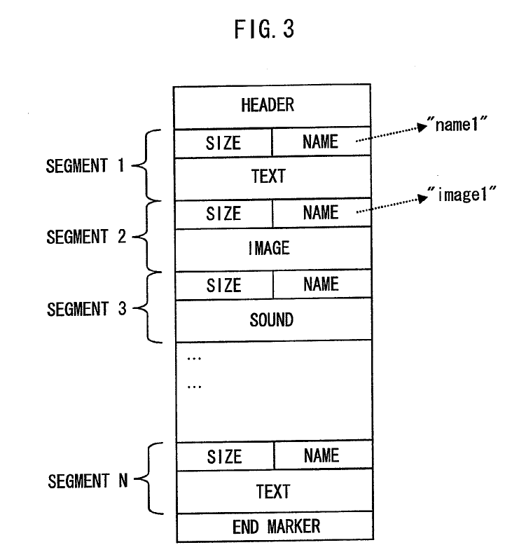

First, the template data will be described using FIG. 3. It will be noted that the template data shown in FIG. 3 have been simplified in order to simplify description. The template data have a format where data called “segments (content information)” are listed between a header portion that is at the beginning and an end marker that marks the end.

Each of the segments has its own size (number of bytes) at the beginning and thereafter includes identification information (an identifier) that identifies each of the segments, such as “image1”, “name1”, “price1” and “comment1”.

As shown in FIG. 3, the template data include text (character string data) that represents a character string included in the browsing screen that is displayed on the portable terminal 60, image data that represent an image included in the browsing screen, and an image identifier (in FIG. 3, “image1”) that identifies the image included in the browsing screen. Moreover, as shown in FIG. 3, there are also cases where the template data include audio data.

Further, although it is not illustrated, there is also a segment in which is stored “display script”. The display script is a script in which is described how components such as the text and the image are to be displayed, and the template data is interpreted based on this information and displayed as a screen.

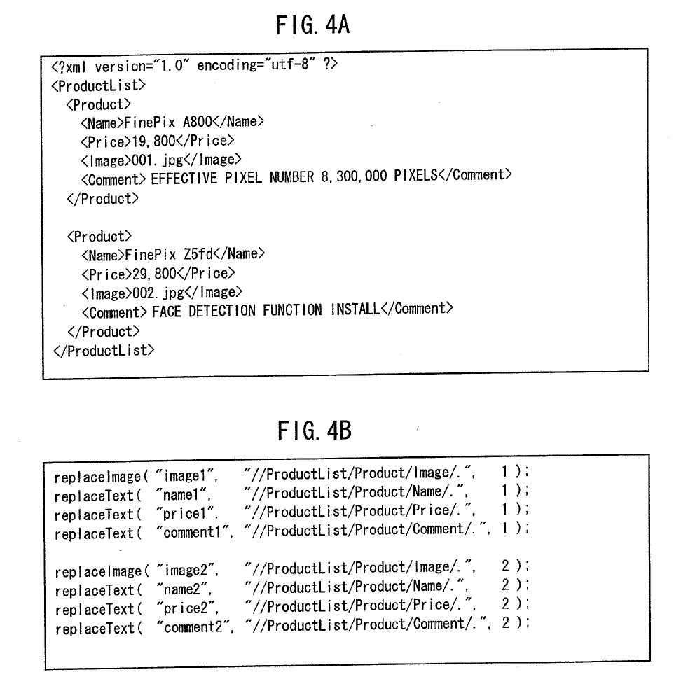

Next, the content update data and the script data will be described using FIG. 4A and FIG. 4B. FIG. 4A shows the content update data. The content update data is data that represent which portion (segment) of the template data and how the template data is to be updated.

Content that is displayed as the browsing screen by the template data is defined by each of the tags shown in FIG. 4A. The tag <Product> represents one product. The tags <Name>, <Price>, <Image> and <Comment> are included in this tag <Product> and respectively represent a name, a price, an image file name and a comment of the product.

The XML format data shown in FIG. 4A is easy to develop for a system developer who does not always have specialized knowledge in regard to multimedia data. However, in the content update data, a portion associated with a graphical user interface (GUI) is missing, and therefore, the template data cannot be created just using this content update data.

Thus, the template data is created by the script data shown in FIG. 4B. The script data is data that represent execution codes, and “replaceImage( )” and “replaceText( )” shown in FIG. 4B represent functions. Further, the notation “//ProductList/Product/Image/.” shown in the argument of each function is called an “XPointer” and is used for specifying the corresponding part of the XML data. Further, the numbers “1” and “2” at the end of the arguments of the functions specify what number the tags are because there are plural tags called “Product” in the XML data shown in FIG. 4A.

Moreover, “image1”, “name1”, “price1” and “comment1” are identifiers that identify the content information and are variable names attached to the segments in the template data. These variable names can be provided as a list from a designer who has created a template.

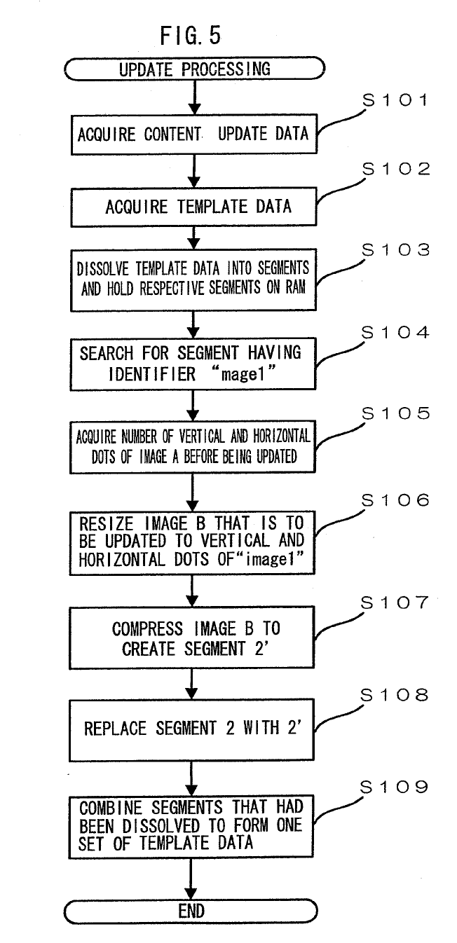

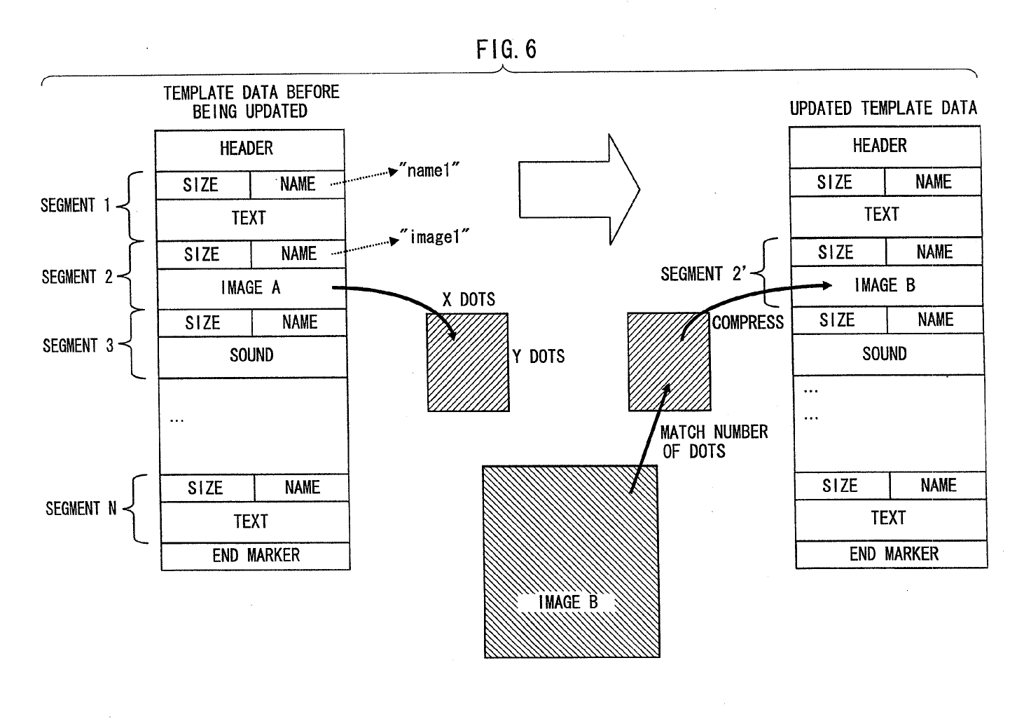

Update processing that is performed using the template data, the content update data and the script data that have been described above will be described using the flowchart of FIG. 5 and the schematic diagram of FIG. 6 illustrating the update processing. This update processing is performed by the aforementioned CPU 81. It will be noted that this flowchart shows processing to update “image1” as an example. Further, in FIG. 6, there are shown two sets of template data: template data before being updated and template data that have been updated by the processing of the flowchart of FIG. 5.

First, in step 101, the content update data is acquired. This may be done by acquiring the data stored in the HDD 82, for example, or by acquiring data from another server as described later. In the next step 102, the template data stored in the HDD 82 is acquired.

In the next step 103, the template data is broke down into segments, and the dissolved segments are respectively held on the RAM 83. In the next step 104, the segment having the name of the identifier “image1” (the name of segment 2 shown in FIG. 6) is searched for.

When the segment “image1” is identified, then in step 105, the number of vertical and horizontal dots of image A before being updated is acquired (in FIG. 6, horizontal X dots and vertical Y dots). In step 106, image B to be updated is resized to match the number of vertical and horizontal dots of “image1”, and in step 107, the data amount of image B is compressed to create an updated segment 2′. This replacement processing is respectively performed when updating segments other than “image1” also.

In the next step 109, the segments that are dissolved and updated are combined to form one set of updated template data, and the processing ends.

The template data that have been updated in this manner can be provided to the portable terminal 60, for example.

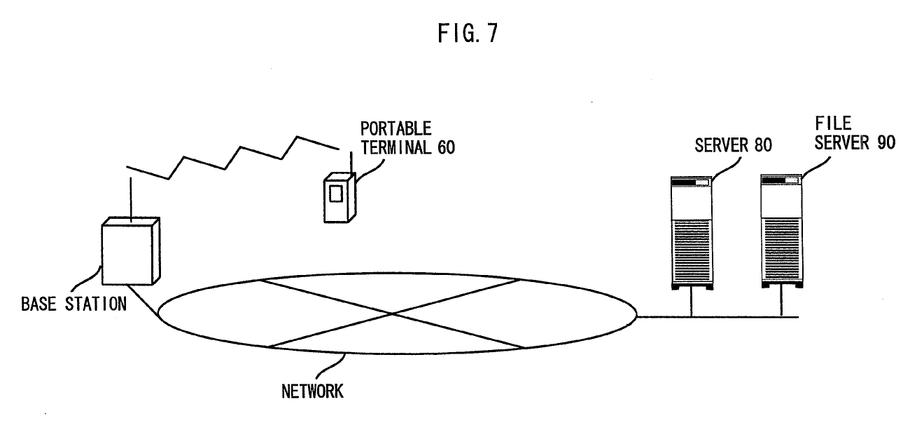

It will be noted that, in the system shown in FIG. 1, there is shown a configuration that includes only a single server 80, but as shown in FIG. 7, a file server 90 that stores the template data, the content update data and the script data may also be disposed in addition to the server 80. In this case, the storage component corresponds to the file server 90. Additionally, the server 80 may also be configured to perform the processing shown in FIG. 5 and processing to provide the template data to the portable terminal 60 or the like.

It will be noted that the flow of processing in the flowchart that has been described above is only one example, and it goes without saying that the processing order can be changed, new steps can be added, and unnecessary steps can be deleted without departing from the scope of the present invention.

As described above, according to the present invention, an information processing device, an information processing method and an information processing program storage medium that enable rich content information to be updated easily can be provided.

What is claimed is:

1. An information processing device comprising:
a storage component that stores browsing screen data that is provided to an external device and creates a browsing screen that is displayed at a display of the external device as a result of the external device interpreting and executing the browsing screen data;
an acquisition component that acquires content update data for updating the browsing screen data; and
an update component that updates the browsing screen data based on the content update data.

2. The information processing device of claim 1, wherein
the browsing screen comprises at least one content segment,
the content update data includes an identifier that identifies the content segment included in the browsing screen, and
the update component updates the browsing screen data by breaking down the browsing screen data into a set of data representing the content segment included in the browsing screen, and replacing the content segment data identified by the identifier included in the content update data with the content update data.

3. The information processing device of claim 1, wherein the browsing screen data includes character string data that represents a character string included in the browsing screen, image data that represents an image included in the browsing screen, and image identification data that identifies the image included in the browsing screen.

4. The information processing device of claim 1, wherein the browsing screen data comprises XML format data.

5. An information processing method comprising:
storing browsing screen data that is provided to an external device and creates a browsing screen that is displayed on a display of the external device as a result of the external device interpreting and executing the browsing screen data;
acquiring content update data for updating the browsing screen data; and
updating the browsing screen data based on the content update data.

6. The information processing method of claim 5, wherein
the browsing screen comprises at least one content segment,
the content update data includes an identifier that identifies the content segment included in the browsing screen, and
the updating updates the browsing screen data by breaking down the browsing screen data into a set of data representing the content segment included in the browsing screen, and replacing the content segment data identified by the identifier included in the content update data with the content update data.

7. The information processing method of claim 5, wherein the browsing screen data includes character string data that represents a character string included in the browsing screen, image data that represents an image included in the browsing screen, and image identification data that identifies the image included in the browsing screen.

8. The information processing method of claim 5, wherein the browsing screen data comprises XML format data.

9. A storage medium storing a program that causes a computer to execute information processing, the computer storing browsing screen data that is provided to an external device and creates a browsing screen that is displayed on a display of the external device as a result of the external device interpreting and executing the browsing screen data, the information processing comprising:
acquiring content update data for updating the browsing screen data; and
updating the browsing screen data based on the content update data.
